(19) United States
(12) Patent Application Publication
(10) Pub. No.: US 2015/0313426 A1
(43) Pub. Date: Nov. 5, 2015

(54) Toilet structure

(71) Applicant: Globe Union Industrial Corp., Taichung City (TW)

(72) Inventors: Chungyi Cheng, Taichung City (TW); Chuwan Hong, Taichung City (TW)

(21) Appl. No.: 14/686,469

(22) Filed: Apr. 14, 2015

(30) Foreign Application Priority Data
Apr. 30, 2014 (CN) 201410182810.3

(51) Int. Cl. A47K 13/26; F16F 1/06

(52) U.S. Cl. CPC A47K 13/26; F16F 1/06; F16F 2236/04; F16F 2238/026

(57) ABSTRACT

A toilet seat contains: a toilet seat, a connecting assembly, a body, and a fixing plate. The toilet seat includes a support, a holder, and a cover; the support has an electronic controlling element, at least one inlet pipe, and an electric wire. The connecting assembly is connected with the support and includes an elongated affix piece, a retaining member, and a pressing member; the affix piece has two penetration portions and two recesses. The retaining member has two cutouts defined on two ends thereof to correspond to the two penetration portions and has two locking portions proximate to the two cutouts. The body includes two accommodating orifices and two connection orifices. The fixing plate is mounted on the two connection orifices and includes two opposite lockers extending outwardly therefrom and inserting through the two penetration portions and the two cutouts to retain with the two locking portions.

### FIELD OF THE INVENTION

The present invention relates to a toilet structure which is connected and removed easily.

### BACKGROUND OF THE INVENTION

A conventional toilet contains a toilet seat and a flushing device which are mounted on a body, wherein the flushing device includes a control interface controlled by a user and includes a water pipe driven by the control interface to spray water, thus flushing and cleaning the toilet.

The body includes a fixing plate made of plastic material, and the fixing plate has two slots defined thereon, the toilet seat has two rails, such that when the toilet seat is pushed toward a water tank from the body, the fixing plate slides along the two rails of the toilet seat, and the fixing plate is connected with the toilet seat by using a retaining structure on the fixing plate, thus fixing the toilet seat with the body.

However, the toilet has disadvantages as follows:

1. The two rails of the toilet seat are retained with the two slots of the fixing plate, so at least one inlet pipe and an electric wire can only fixed on a peripheral side of the toilet seat, thus exposing the at least inlet pipe and the electric wire outside.

2. The at least inlet pipe and the electric wire are pulled outwardly or the water leaks out of the at least one inlet pipe easily, since they expose outside.

3. The toilet is fixed in a bathroom difficultly, because the at least inlet pipe and the electric wire expose outside.

4. The toilet is assembled inconveniently due to the toilet seat is slidably retained with the body forward and backwardly.

5. As desiring to remove the toilet seat, a button on the peripheral side of the toilet seat is pressed to drive the retaining structure, and then the toilet seat is pushed backward to remove from the body troublesomely.

The present invention has arisen to mitigate and/or obviate the afore-described disadvantages.

### SUMMARY OF THE INVENTION

One aspect of the present invention is to provide a toilet structure in which at least one inlet pipe and an electric wire of a toilet seat are directly inserted into two accommodating orifices of a body, thus arranging the at least one inlet pipe and the electric wire in the body neatly.

Further aspect of the present invention is to provide a toilet structure in which the toilet seat is fixed on and is removed from the body by using a fixing plate, thereby positioning a toilet in a bathroom easily.

Another aspect of the present invention is to provide a toilet structure in which an insertion sheet of a support of the toilet seat is inserted into a slot of the fixing plate to fix the toilet seat on the fixing plate, a connecting assembly is in connection with the fixing plate accurately and quickly, and the connecting assembly and the fixing plate are removed conveniently by pressing a press block of the connecting assembly.

To obtain the above aspects, a toilet seat provided by the present invention contains: a toilet seat, a connecting assembly, a body, and a fixing plate.

The toilet seat includes a support, a holder extending outwardly from the support, and a cover connected with a front side of the support and located above the holder. The support has an electronic controlling element, at least one inlet pipe arranged on a bottom end thereof, and an electric wire fixed on the bottom end thereof.

The connecting assembly is connected with the bottom end of the support of the toilet seat and includes an elongated affix piece, a retaining member, and a pressing member. The affix piece has two penetration portions and two recesses, wherein the retaining member is formed in an elongated bar shape and horizontally slides in the two recesses, the retaining member has two cutouts defined on two ends thereof to correspond to the two penetration portions and has two locking portions arranged proximate to the two cutouts. The pressing member is mounted on one side of the affix piece and is coupled with one end of the retaining member, such that when the pressing member is pressed, it drives the retaining member to move horizontally, and when the pressing member is released, it drives the retaining member to move back to an original position.

The body includes two accommodating orifices defined on a peripheral side of a top surface thereof and includes two connection orifices formed on the top surface thereof; wherein each accommodating orifice is employed to insert each of the at least one inlet pipe and the electric wire.

The fixing plate is mounted on the two connection orifices of the body and includes two opposite lockers extending outwardly from two ends of one side thereof and inserting through the two penetration portions of the affix piece and the two cutouts of the retaining member to retain with the two locking portions, such that the connecting assembly and the toilet seat are in connection with the body.

### BRIEF DESCRIPTION OF THE DRAWINGS

FIG. 1 is a perspective view showing the exploded components of most parts of a toilet structure according to a preferred embodiment of the present invention.

FIG. 2 is a perspective view showing the exploded components of a toilet seat and a connecting assembly of the toilet structure according to the preferred embodiment of the present invention.

FIG. 3 is a perspective view showing the exploded components of a body and a fixing plate of the toilet structure according to the preferred embodiment of the present invention.

FIG. 4 is a perspective view showing the exploded components of the connecting assembly of the toilet structure according to the preferred embodiment of the present invention.

FIG. 5 is a perspective view showing the assembly of the connecting assembly of the toilet structure according to the preferred embodiment of the present invention.

FIG. 6 is a perspective view showing the operation of the connecting assembly and the fixing plate of the toilet structure according to the preferred embodiment of the present invention.

FIG. 7 is another perspective view showing the operation of the connecting assembly and the fixing plate of the toilet structure according to the preferred embodiment of the present invention.

FIG. 8 is a cross sectional view showing the operation of the connecting assembly and the fixing plate of the toilet structure according to the preferred embodiment of the present invention.

FIG. 9 is a perspective view showing the operation of the connecting assembly of the toilet structure according to the preferred embodiment of the present invention.

FIG. 10 is a cross sectional view showing the operation of a part of the toilet seat and the fixing plate of the toilet structure according to the preferred embodiment of the present invention.

FIG. 11 is an amplified cross sectional of a part of FIG. 10.

FIG. 12 is a cross sectional view showing the operation of a support of the toilet seat of the toilet structure according to the preferred embodiment of the present invention.

### DETAILED DESCRIPTION OF THE PREFERRED EMBODIMENTS

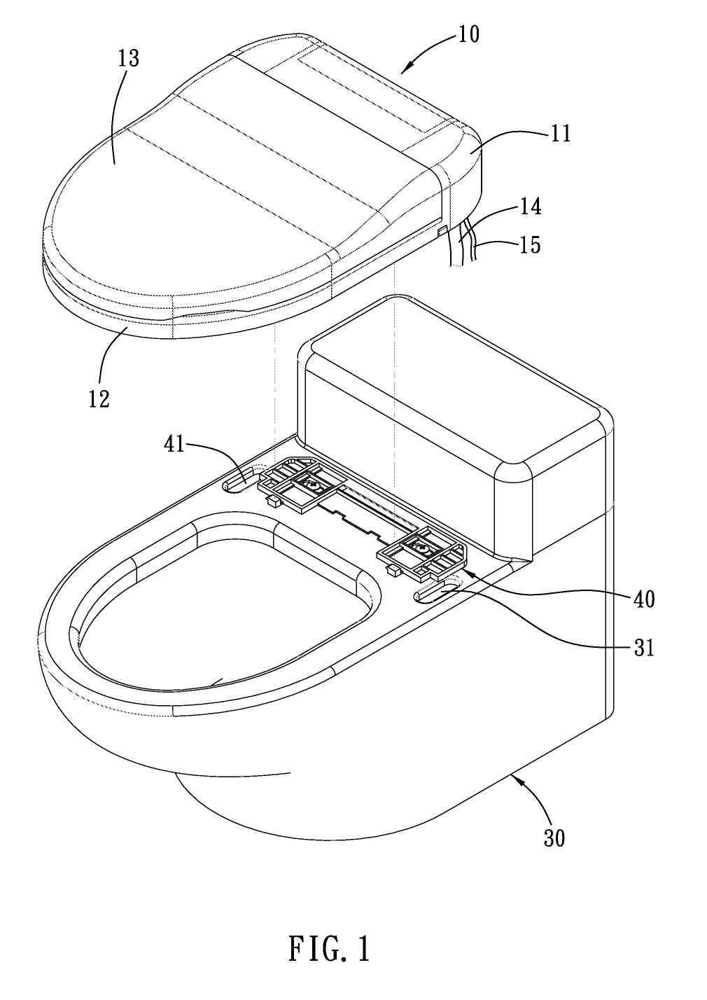

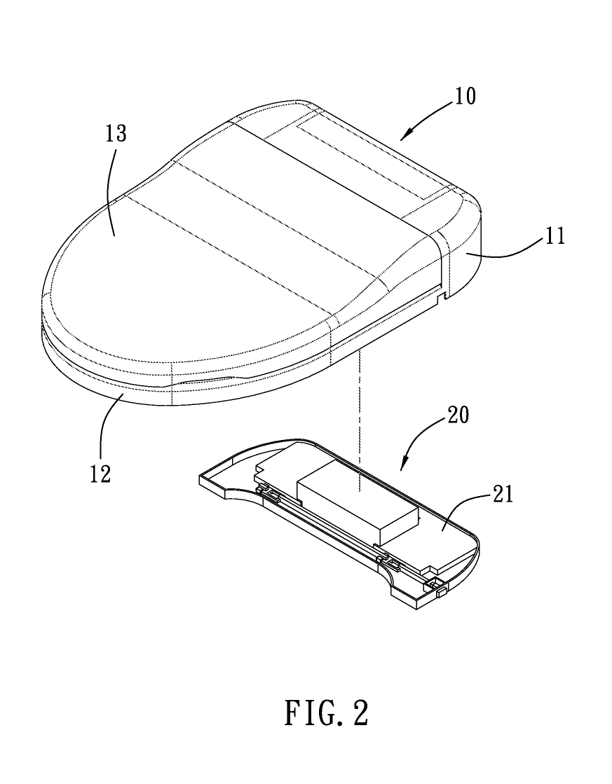

With reference to FIGS. 1 to 3, a toilet structure according to a preferred embodiment of the present invention comprises: a toilet seat 10, a connecting assembly 20, a body 30, a fixing plate 40, and two clampers 50.

The toilet seat 10 is an intelligent toilet seat and includes a support 11, a holder 12 extending outwardly from the support 11, and a cover 13 connected with a front side of the support 11 and located above the holder 12. The support 11 has an electronic controlling element (not shown), at least one inlet pipe 14 arranged on a bottom end thereof, and an electric wire 15 fixed on the bottom end thereof. The cover 13 is rotatably covered on a top surface of the holder 12.

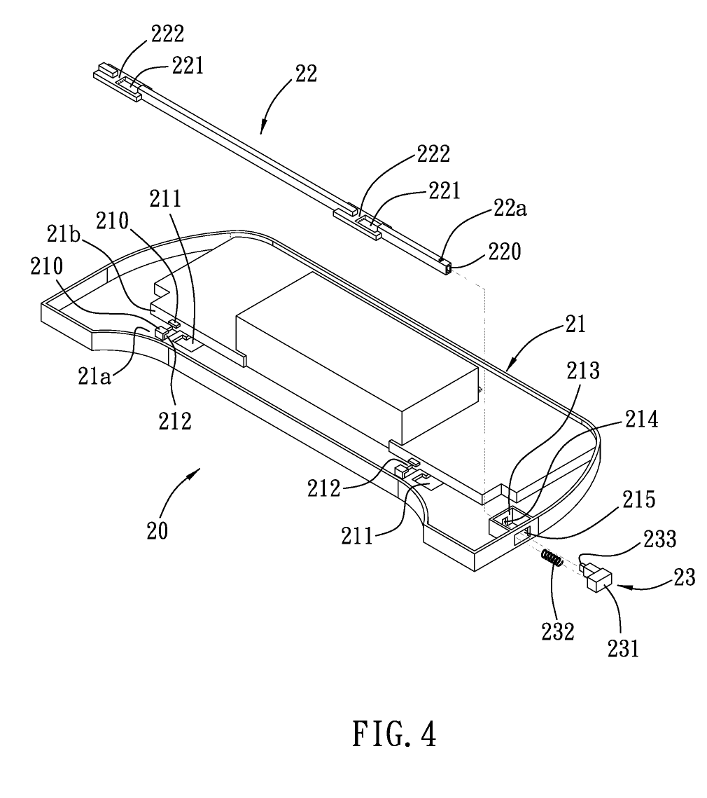

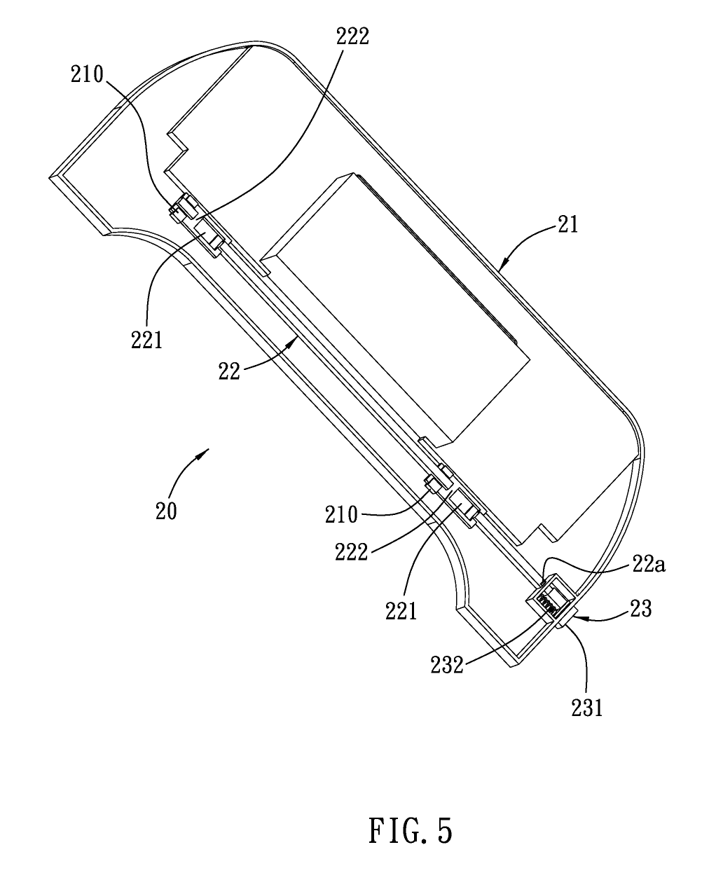

Referring to FIGS. 4 and 5, the connecting assembly 20 is connected with the bottom end of the support 11 of the toilet seat 10 and includes an elongated affix piece 21, a retaining member 22, and a pressing member 23; the affix piece 21 has two penetration portions 211 symmetrically formed thereon and two recesses 212 adjacent to the two penetration portions 211, wherein the two recesses 212 are defined by two opposite guiding blocks 210, a bottom fence 21a, and a peripheral fence 21b; the retaining member 22 is formed in an elongated bar shape and horizontally slides in the two recesses 212, wherein the retaining member 22 has two cutouts 221 defined on two ends thereof to correspond to the two penetration portions 211 and has two locking portions 222 arranged proximate to the two cutouts 221; the pressing member 23 is mounted on one side of the affix piece 21 and is coupled with a coupling segment 220 on one end of the retaining member 22, such that when the pressing member 23 is pressed, it drives the retaining member 22 to move horizontally, and when the pressing member 23 is released, it drives the retaining member 22 to move back to an original position.

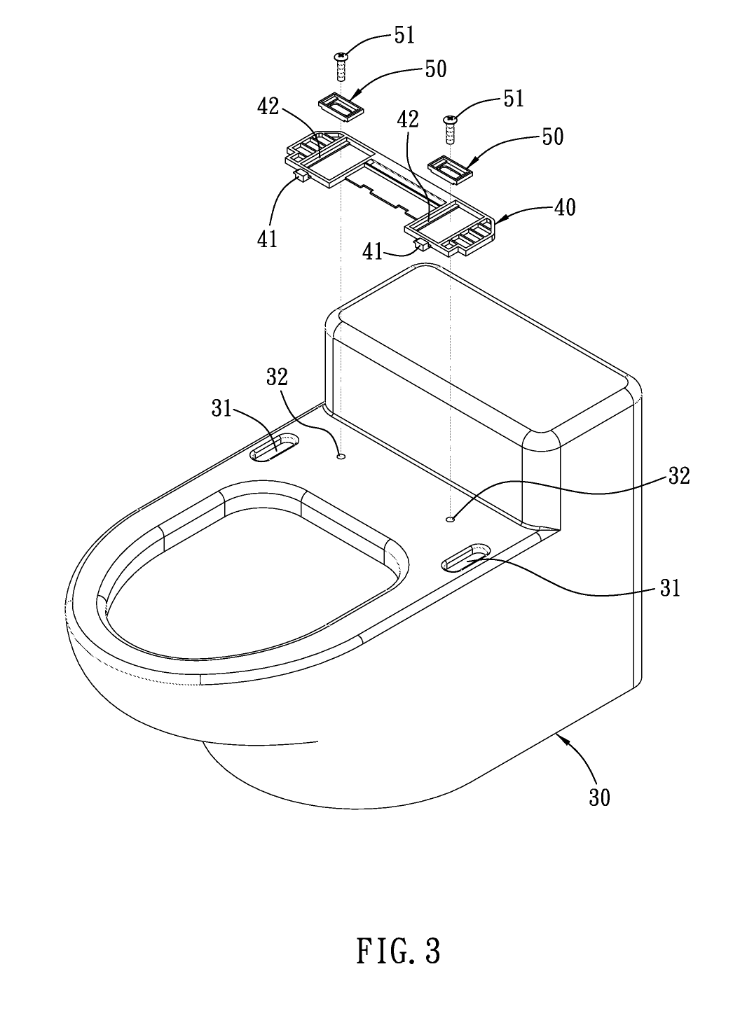

As shown in FIG. 3, the body 30 includes two accommodating orifices 31 defined on a peripheral side of a top surface thereof and includes two connection orifices 32 formed on the top surface thereof; wherein each accommodating orifice 31 is employed to insert each of the at least one inlet pipe 14 and the electric wire 15.

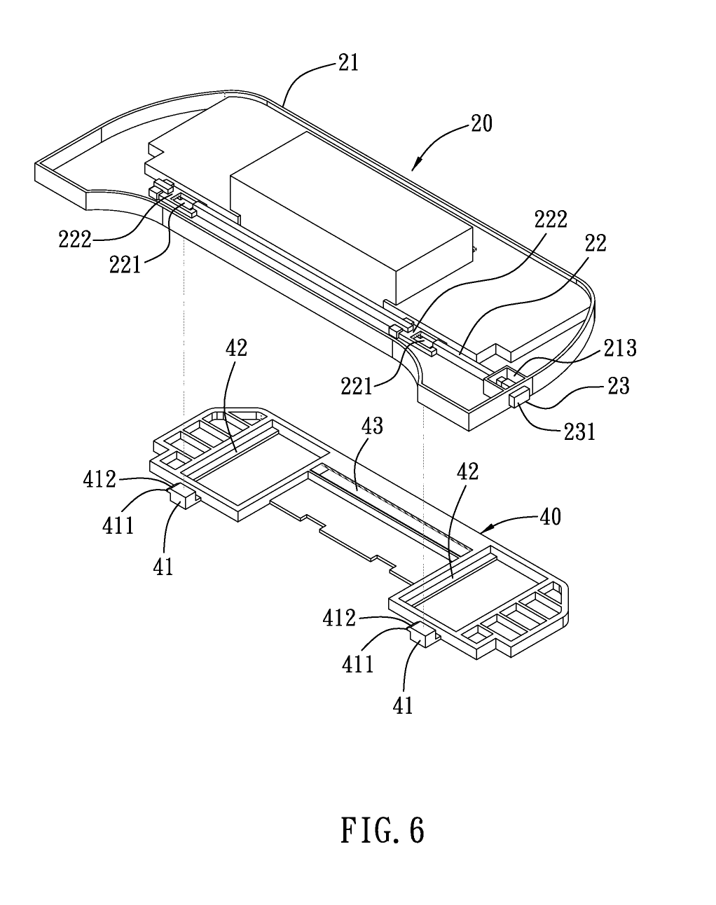

As illustrated in FIGS. 3 and 6, the fixing plate 40 is mounted on the two connection orifices 32 of the body 30 and includes two opposite lockers 41 extending outwardly from two ends of one side thereof and inserting through the two penetration portions 211 of the affix piece 21 and the two cutouts 221 of the retaining member 22 to retain with the two locking portions 222, such that the connecting assembly 20 and the toilet seat 10 are in connection with the body 30, the two opposite lockers 41 remove from the two locking portions 222 and then move across the two cutouts 221 and the two penetration portions 211, after the pressing member 23 is pressed, and the connecting assembly 20 and the toilet seat 10 remove from the body 30.

Each locker 41 has a hooking portion 411 extending outwardly from an inner side thereof to retain with each locking portion 222. The hooking portion 411 has a tilted guiding face 412 defined on a top surface thereof, such that when the connecting assembly 20 and the fixing plate 40 are coupled together, the titled guiding face 412 of the hooking portion 411 of each locker 41 pushes each cutout 221 upwardly and pushes the retaining member 22 inwardly, hence each locker 41 moves across each cutout 221, and the pressing assembly 23 flexibly presses the retaining member 22, thus retaining each locking portion 222 of the retaining member 22 with the hooking portion 411 of each locker 41 quickly.

The affix piece 21 has a receiving notch 213 defined on an inner peripheral side thereof to receive the pressing member 23, the affix piece 21 also has a first through orifice 214 formed on an inner wall of the receiving notch 213 and has a second through orifice 215 formed on an outer wall thereof, such that the coupling segment 220 of the retaining member 22 is inserted into the receiving notch 213 from the first through orifice 214. The pressing member 23 has a press block 231 and a resilient element 232; the press block 231 has a protrusion 233 extending outwardly from an inner side thereof to engage with the coupling segment 220 which is inserted into the receiving notch 213; the resilient element 232 is a compression spring and is fixed between the press block 231 and the receiving notch 213 to abut against the press block 231, such that when the press block 231 is not pressed, it extends out of the second through orifice 215 of the affix piece 21 so as to be pressed by a user, and after the press block 231 is released, it drives the retaining member 22 to move back to the original position by using the resilient element 232. The retaining member 22 has a limiting projection 22a arranged adjacent to the coupling segment 220, such that when the resilient element 232 pushes the press block 231 to move outwardly with the retaining member 22, the limiting projection 22a contacts with the receiving notch 213 of the affix piece 21 to stop the press block 231 outwardly removing from the affix piece 21, and the limiting projection 22a and the resilient element 232 limit a horizontal movement of the press block 231 and the retaining member 22 within a certain range, thus removing or fixing the pressing member 23 from or on the retaining member 22.

Each clamper 50 is mounted on each of two ends of the fixing plate 40, and a fastening element 51 (such as a screw bolt) is inserted through each clamper 50 and the fixing plate 40 to screw with each of the two connection orifices 32 of the body 30, thus connecting the fixing plate 40 with the body 30.

The fixing plate 40 includes two sliding rails 42 arranged on two ends thereof, such that before the two clampers 50 are mounted on the fixing plate 40, they slide to a suitable position along the two sliding rails 42.

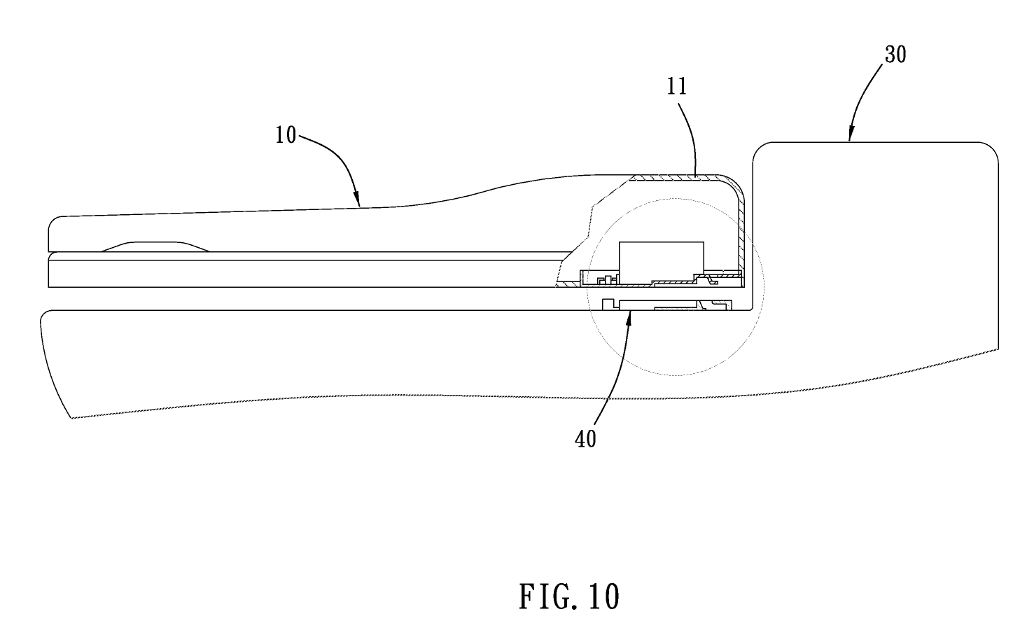

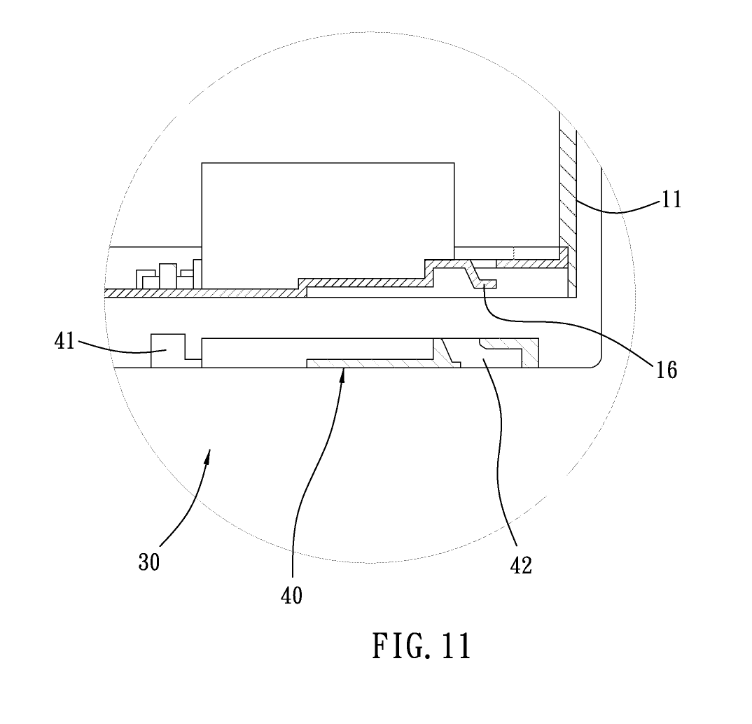

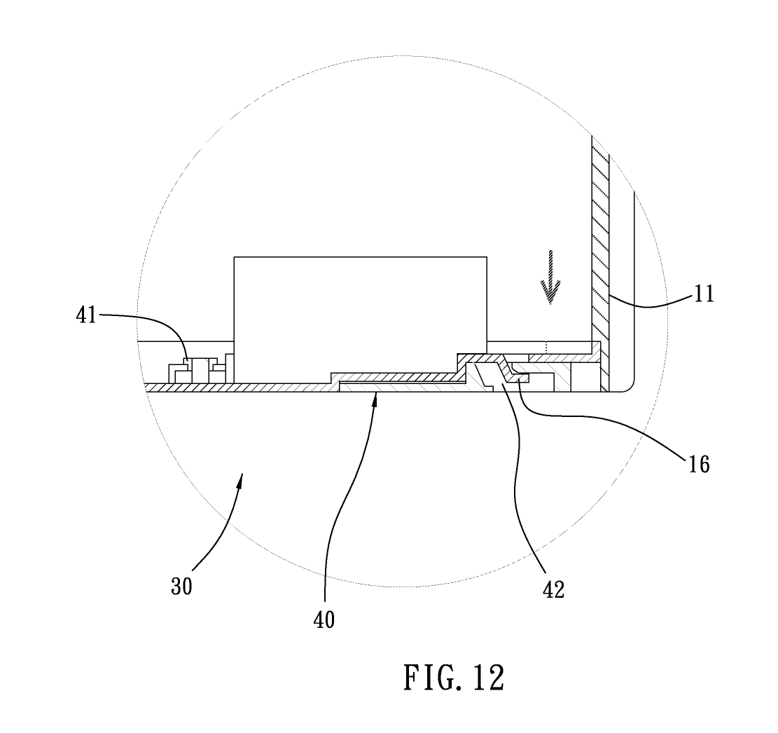

With reference to FIGS. 10 and 11, the support 11 of the toilet seat 10 has a L-shaped insertion sheet 16; the fixing plate 40 further includes a L-shaped slot 43 formed thereon as shown in FIGS. 6 and 12, such that the insertion sheet 16 is obliquely inserted in the slot 43 to reinforce a connection of the toilet seat 10 and the body 30 and to limit a removal of the toilet seat 10 from the body 30. In addition, the two cutouts 221 of the connecting assembly 20 are aligned with the two opposite lockers 41 of the fixing plate 40 accurately and quickly by ways of the insertion sheet 16 and the slot 43.

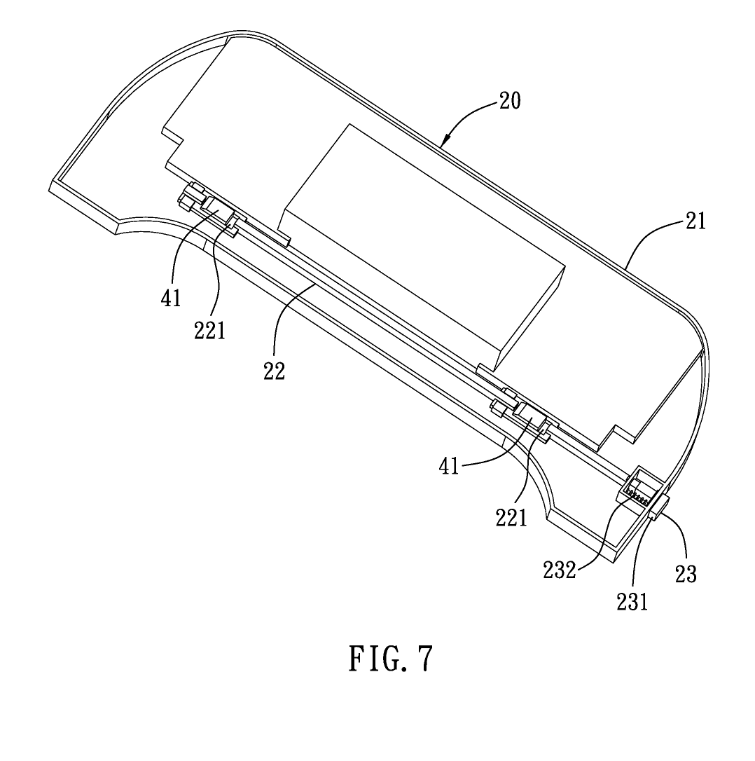

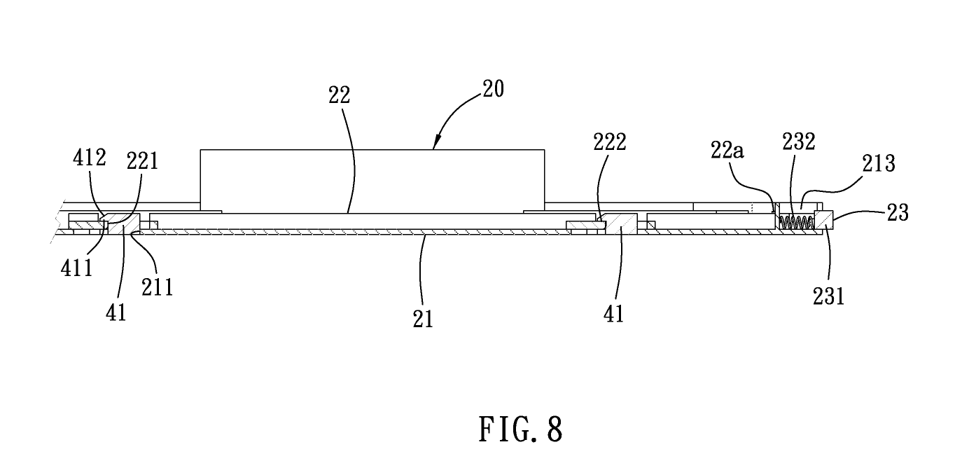

Referring to FIGS. 1 and 3, in assembly, the body 30 is mounted on the fixing plate 40 by using two fastening elements 51 of the two clampers 50, and the insertion sheet 16 of the support 11 of the toilet seat 10 is inserted into the slot 43 of the fixing plate 40, as shown in FIGS. 10 and 11, such that the connecting assembly 20 is aligned with the fixing plate 40 quickly, and the toilet seat 10 is pressed downwardly, hence the two opposite lockers 41 of the fixing plate 40 are retained with the two locking portions 222 through the two cutouts 221 of the retaining member 22, as illustrated in FIGS. 7 and 8, and the insertion sheet 16 is inserted into the slot 43, thus assembling a toilet completely.

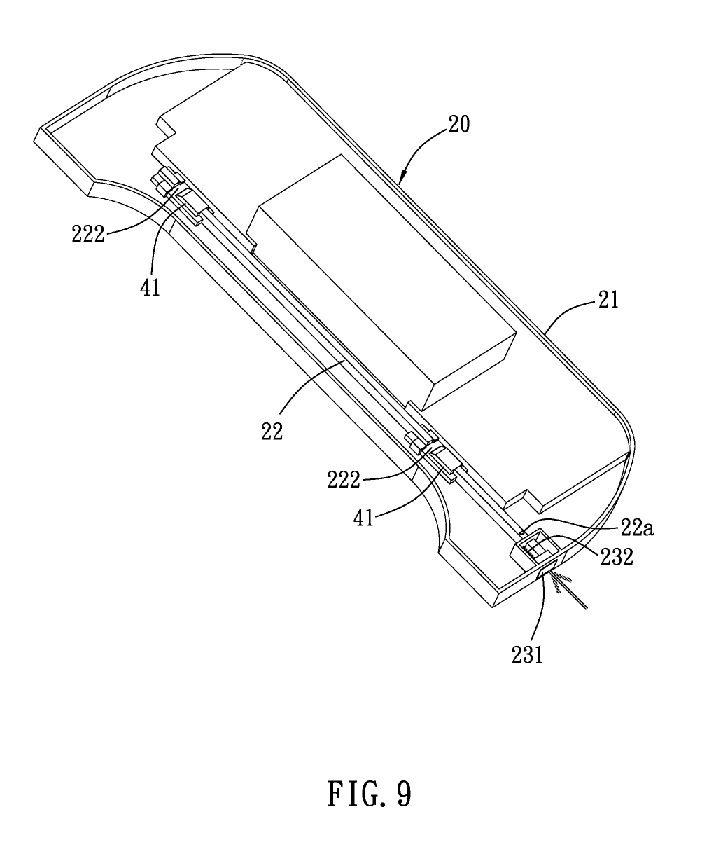

With reference to FIG. 9, as desiring to clean or maintain the body 30, the press block 231 of the connecting assembly 20 drives the retaining member 22 to move inwardly, and then the two cutouts 221 of the retaining member 22 horizontally remove from the two opposite lockers 41 of the fixing plate 40, such that the toilet seat 10 is pulled upwardly so that the insertion sheet 16 of the support 11 is removed from the slot 43 of the fixing plate 40, thus removing the toilet seat 10 from the fixing plate 40 quickly.

Accordingly, the toilet structure of the present invention has advantages as follows:

1. The at least one inlet pipe 14 and the electric wire 15 of the toilet seat 10 are directly inserted into the two accommodating orifices 31 of the body 30, thus arranging the at least one inlet pipe 14 and the electric wire 15 in the body 30 neatly.

2. The toilet seat 10 is fixed on and is removed from the body 30 by using the fixing plate 40, thereby positioning the toilet in a bathroom easily.

3. The insertion sheet 16 of the support 11 of the toilet seat 10 is inserted into the slot 43 of the fixing plate 40 to fix the toilet seat 10 on the fixing plate 40, the connecting assembly 20 is in connection with the fixing plate 40 accurately and quickly, and the connecting assembly 20 and the fixing plate 40 are removed conveniently by pressing the press block 231 of the connecting assembly 20.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A toilet seat comprising:
a toilet seat including a support, a holder extending outwardly from the support, and a cover connected with a front side of the support and located above the holder; the support having an electronic controlling element, at least one inlet pipe arranged on a bottom end thereof, and an electric wire fixed on the bottom end thereof;
a connecting assembly connected with the bottom end of the support of the toilet seat and including an elongated affix piece, a retaining member, and a pressing member; the affix piece having two penetration portions and two recesses, wherein the retaining member is formed in an elongated bar shape and horizontally slides in the two recesses, the retaining member has two cutouts defined on two ends thereof to correspond to the two penetration portions and has two locking portions arranged proximate to the two cutouts;
the pressing member is mounted on one side of the affix piece and is coupled with one end of the retaining member, such that when the pressing member is pressed, it drives the retaining member to move horizontally, and when the pressing member is released, it drives the retaining member to move back to an original position;
a body including two accommodating orifices defined on a peripheral side of a top surface thereof and including two connection orifices formed on the top surface thereof; wherein each accommodating orifice is employed to insert each of the at least one inlet pipe and the electric wire;
a fixing plate mounted on the two connection orifices of the body and including two opposite lockers extending outwardly from two ends of one side thereof and inserting through the two penetration portions of the affix piece and the two cutouts of the retaining member to retain with the two locking portions, such that the connecting assembly and the toilet seat are in connection with the body.

2. The toilet seat as claimed in claim 1, wherein the two recesses are defined by two opposite guiding blocks, a bottom fence, and a peripheral fence.

3. The toilet seat as claimed in claim 1, wherein each locker has a hooking portion extending outwardly from an inner side thereof to retain with each locking portion.

4. The toilet seat as claimed in claim 3, wherein the hooking portion has a tilted guiding face defined on a top surface thereof, such that when the connecting assembly and the fixing plate are coupled together, the titled guiding face of the hooking portion of each locker pushes each cutout upwardly and pushes the retaining member inwardly, hence each locker moves across each cutout, and the pressing assembly flexibly presses the retaining member, thus retaining each locking portion of the retaining member with the hooking portion of each locker.

5. The toilet seat as claimed in claim 1, wherein the affix piece has a receiving notch defined on an inner peripheral side thereof, the affix piece also has a first through orifice formed on an inner wall of the receiving notch and has a second through orifice formed on an outer wall thereof; the pressing member has a press block and a resilient element for abutting against the press block, such that when the press block is not pressed, it extends out of the second through orifice of the affix piece so as to be pressed by a user; the press block has a protrusion extending outwardly from an inner side thereof; the resilient element is fixed between the press block and the receiving notch.

6. The toilet seat as claimed in claim 5, wherein the retaining member has a limiting projection arranged adjacent to the coupling segment, such that when the resilient element pushes the press block to move outwardly with the retaining member, the limiting projection contacts with the receiving notch of the affix piece to stop the press block outwardly removing from the affix piece, and the limiting projection and the resilient element limit a horizontal movement of the press block and the retaining member within a certain range, thus removing or fixing the pressing member from or on the retaining member.

7. The toilet seat as claimed in claim 5, wherein the resilient element is a compression spring.

8. The toilet seat as claimed in claim 5, wherein the protrusion engages with the coupling segment which is inserted into the receiving notch.

9. The toilet seat as claimed in claim 1 further comprising two clampers, wherein each clamper is mounted on each of two ends of the fixing plate, and a fastening element is inserted through each clamper and the fixing plate to screw with each of the two connection orifices of the body, thus connecting the fixing plate with the body.

10. The toilet seat as claimed in claim 9, wherein the fastening element is a screw bolt.

11. The toilet seat as claimed in claim 9, wherein the fixing plate includes two sliding rails arranged on two ends thereof, such that the two clampers slide along the two sliding rails.

12. The toilet seat as claimed in claim 1, wherein the support of the toilet seat has a L-shaped insertion sheet; the fixing plate further includes a L-shaped slot formed thereon, such that the insertion sheet is obliquely inserted in the slot.
